(19) United States
(12) Patent Application Publication
(10) Pub. No.: US 2019/0305422 A1
(43) Pub. Date: Oct. 3, 2019

(54) ANTENNA BEAMWIDTH CONTROL

(71) Applicant: Intel Corporation, Santa Clara, CA (US)

(72) Inventors: Debabani Choudhury, Thousand Oaks, CA (US); Shuhei Yamada, Hillsboro, OR (US)

(21) Appl. No.: 15/942,026

(22) Filed: Mar. 30, 2018

(51) Int. Cl. H01Q 3/44; G01S 13/93

(52) U.S. Cl. CPC H01Q 3/44; G01S 13/931

(57) ABSTRACT

An antenna system including an antenna configured to emit an electromagnetic wave, and a beamwidth controller disposed on the antenna and configured to align with a magnetic or electric field direction of the electromagnetic wave, and when the electromagnetic wave at least partially or wholly propagates through the beamwidth controller, resonate and induce a magnetic field to interact with the electromagnetic wave to control a beamwidth of the electromagnetic wave based on a permittivity or permeability of the beamwidth controller.

### BACKGROUND

Vehicle-embedded radar and communication systems have application-dependent antenna beamwidth, gain pattern, and scanning angles.

In radar sensing systems, a narrower beamwidth generally reduces spatial ambiguity, and improves resolution and sensing. In wireless communication systems, higher directivity achieves better range of coverage resulting in improved link budget, and a narrower beamwidth makes communications more secure. Antenna array techniques are often used to achieve desired beam characteristics, such as higher directivity, narrower beamwidth, and beam scanning capability. In radar sensing systems, however, narrow beamwidth can result in longer scanning times if the scanning area or target is relatively large compared to the beamwidth. On the other hand, low directivity with larger beamwidth significantly reduces sensing distances and lowers resolution

In wireless communication systems, a beam search process is often required to obtain a best possible scan direction with a narrow beamwidth, but this approach takes a long time and remains inefficient. Such an approach involves beam refinement/broadening techniques requiring fine control of each antenna element in an array involving complex algorithms.

Due to the disadvantages with application dependencies, it is desired to have the beamwidth be adaptively controlled so that one radar system can be reconfigured and cover a different sensing area or target, and also to improve efficiency of the beam search process in wireless communication systems.

### BRIEF DESCRIPTION OF THE DRAWINGS

FIGS. 1A and 1B illustrate a beamwidth controller in accordance with aspects of disclosure.

FIG. 2A (FIGS. 2A-1 through 2A-7) illustrates artificial magnetic metamaterial resonator cells.

FIG. 2B (FIGS. 2B-1 through 2B-6) illustrates Resonant Electric (ELC) metamaterial resonator cells.

FIGS. 3A and 3B illustrate an antenna system in accordance with an aspect of the disclosure.

FIG. 3C illustrates a comparison plot of radiation patterns for vertical and horizontal polarizations with the beamwidth controller of FIG. 3, along with a radiation pattern of a standard patch antenna.

FIGS. 4A and 4B illustrate an antenna system in accordance with an aspect of the disclosure.

FIGS. 5A-5C illustrate an antenna system in accordance with an aspect of the disclosure.

FIGS. 5D and 5E illustrate horizontal-plane radiation pattern results for the system of FIGS. 5A and 5B.

FIGS. 6A-6C illustrate an antenna system in accordance with an aspect of the disclosure.

FIGS. 6D-6F illustrate horizontal-plane radiation patterns for the system of FIGS. 6A-6C.

FIGS. 7A-7B illustrate an antenna system in accordance with an aspect of the disclosure.

FIG. 8 illustrates a flowchart of a method in accordance with an aspect of the disclosure.

FIG. 9A illustrates wireless or radar equipment in accordance with aspects of the disclosure.

FIG. 9B illustrates the radar or communication equipment of FIG. 9A embedded in a vehicle.

### DESCRIPTION OF THE ASPECTS

The present disclosure is directed to a beamwidth controller in combination with a dual/multi-polarization antenna for adaptive beamwidth control. By applying the beamwidth controller to a wireless communication system, beam search/tracking capabilities can be improved with adaptive beamwidth control characteristics.

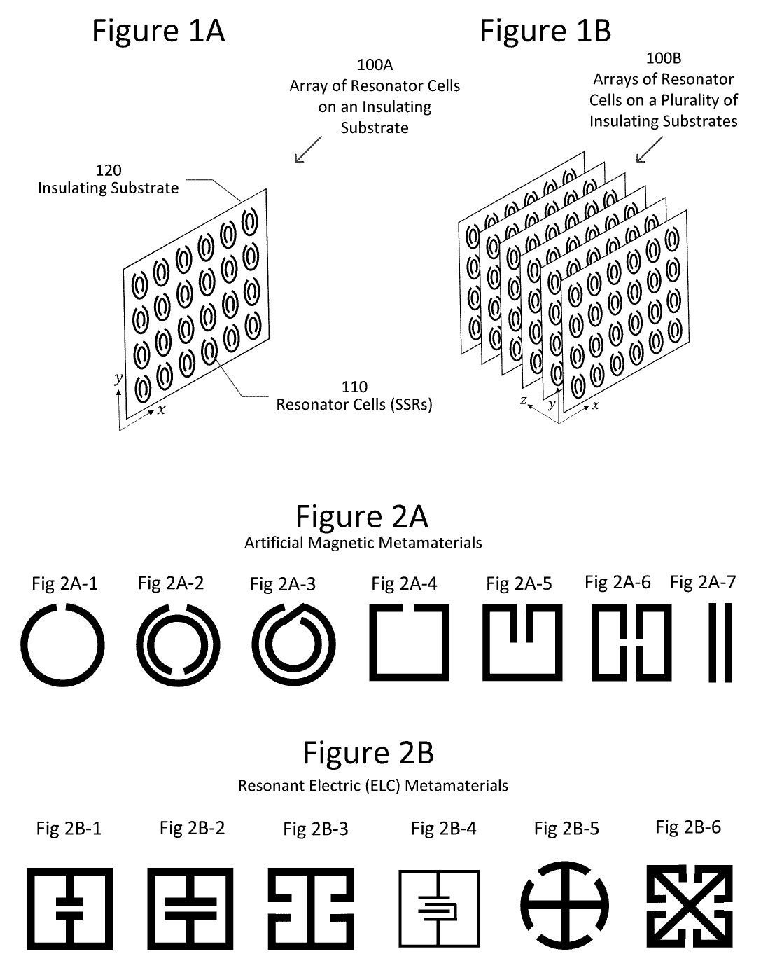

FIGS. 1A and 1B illustrate a beamwidth controller 100 in accordance with aspects of disclosure.

A beamwidth controller 100 comprises an insulating substrate 120 on which resonator cells 110 are formed. In this example, the resonator cells are Split Ring Resonators (SRRs). SRRs are artificially-produced structures common to metamaterials. SSRs create a magnetic coupling to an applied electromagnetic field. By way of example, the permeability and/or permittivity of the material is altered with a periodic array of SSRs. A single SRR comprises a pair of enclosed loops with splits in them at opposite ends. The loops are made of a nonmagnetic metal, such as copper, and have a small gap there between. The loops may be concentric, or square, and gapped as needed. A magnetic field penetrating the metal rings will induce rotating currents in the rings, which produce their own flux to enhance or oppose the incident field depending on the SRRs resonant properties and the alignment with respect to antenna polarization. The small gaps between the rings produce capacitance values which lower the resonating frequency.

The beamwidth controller 100 may comprise a two-dimensional array 100A of resonator cells 110 on a single insulating substrate 120, as shown in FIG. 1A. Alternatively, the beamwidth controller 100 may comprise a three-dimensional array 100B of resonator cells on a plurality insulating substrates 120, as shown in FIG. 1B. The beamwidth controller 100 may comprise an n-dimensional array of a plurality insulating substrates 120 with resonator cells 110.

SRRs manipulate permittivity ε and permeability μl of materials and a behavior of an electromagnetic wave passing therethrough. In order to manipulate material properties of the beamwidth controller 100, the beamwidth controller 100 comprises periodic cells based on the resonator cell 110 as shown in FIG. 1. The resonator cell based beamwidth controller 100 behaves as a material having altered properties. The beamwidth controller 100 is designed to resonate and induce electric and/or magnetic fields which interact with an electromagnetic wave propagating through the beamwidth controller 100. The effective permittivity ε_{eff} and effective permeability μ_{eff} of the beamwidth controller 100 are expressed as:

$$\begin{matrix}{ɛ}_{eff} ( ω ) = 1 - \frac{{ω}_{p}^{2}}{{ω}^{2} + i ω γ} \\ and & ( Equation 1 ) \\ {μ}_{eff} ( ω ) = 1 - \frac{F {ω}^{2}}{{ω}^{2} - {ω}_{0}^{2} - i ω γ} & ( Equation 2 )\end{matrix}$$

where ωₚ is plasma frequency, which refers to the frequency at which the permittivity changes from negative to positive, ω is the angular frequency, γ is the dumping factor of a resonator cell 110, ω₀ is the resonant frequency, and F is the filling factor of the resonator cell. The filling factor is an indication of how much a magnetic field is concentrated over the resonator cell.

FIG. 2A (FIGS. 2A-1 through 2A-7 illustrates example artificial magnetic metamaterial resonator cells 110. The resonator cells 110 are not limited to being SSRs. FIGS. 2A-1 through 2A-3 illustrate exemplary forms of resonator cells having a circular shape. FIGS. 2A-4 through 2A-6 illustrate exemplary forms of resonator cells 110 having a square shape. FIG. 2A-7 illustrates an exemplary form of resonator cell 110 have a straight or wire shape.

FIG. 2B (FIGS. 2B-1 through 2B-6) illustrates exemplary Resonant Electric (ELC) metamaterial resonator cells having various other shapes. Further, the resonator cell 110 may alternatively be a mushroom-shaped resonator, which as is known, comprises metal patch on top coupled to ground.

In one embodiment, the beamwidth controller 100 may comprises a plurality of types of resonator cells in any pattern or combination as applicable.

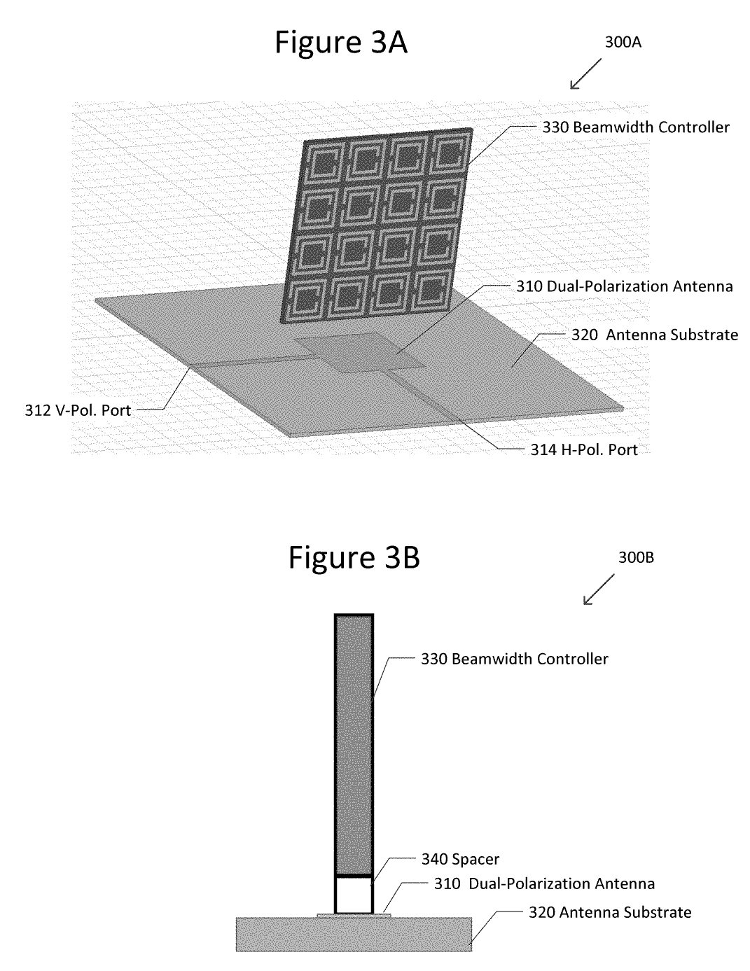

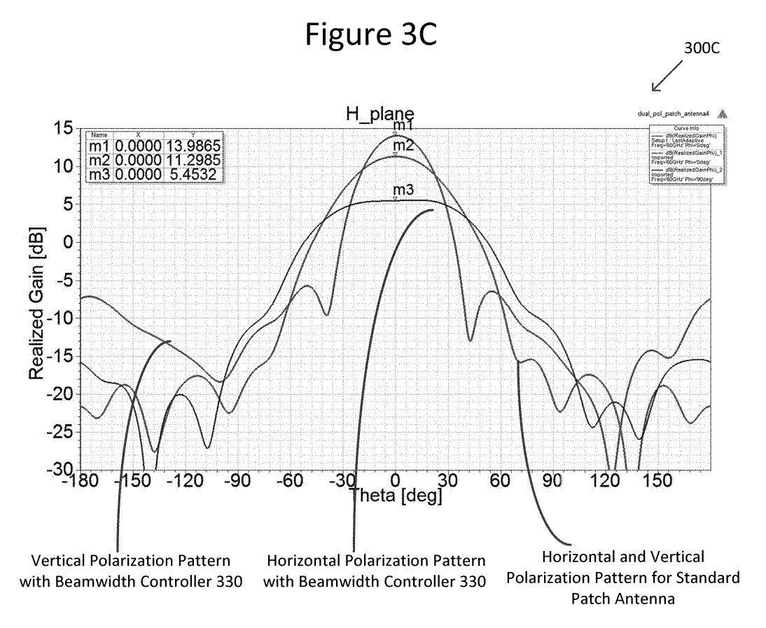

FIGS. 3A and 3B illustrate an antenna system 300 in accordance with an aspect of the disclosure, with FIG. 3A being a top view, and FIG. 3B being a side view.

The antenna system 300 comprises a single dual-polarized patch antenna 310 formed on an antenna substrate 320, a beamwidth controller 330, and a spacer 340.

The dual-polarized patch antenna 310 comprises a vertical polarization port 312 and a horizontal polarization port 314. The dual-polarization patch antenna 310 is configured to emit an electromagnetic wave when one or both of the ports 312, 314 is excited.

The beamwidth controller 330, as described above with respect to the beamwidth controller 100 of FIG. 1, comprises and array of resonator cells, and is placed on top of and perpendicular to the dual-polarization patch antenna 310. The orientation of the beamwidth controller 330 impacts the radiation pattern of the antenna 310, resulting in polarization-specific beamwidth variations. The beamwidth controller 330 is clamped on top of the antenna 310 by fixtures or spacers 340 from sides to align the antenna 310 and the beamwidth controller 330. The beamwidth controller 330 is not limited to having the array of resonators shown, but may have any one or more of the types of resonator cells, such as the ones described above with respect to FIGS. 2A and 2B.

The beamwidth controller 330 is configured to be aligned with a magnetic and/or electric field direction of the electromagnetic wave, wherein when the electromagnetic wave propagates through the beamwidth controller 330, the beamwidth controller 330 is configured to resonate and induce a magnetic and/or electric field to interact with the electromagnetic wave to control a beamwidth of the electromagnetic wave based on the a permittivity and/or permeability of the beamwidth controller 330.

Conventional dual-polarized antennas and antenna arrays using standard patch type elements exhibit a same beamwidth for both vertically-polarized (V-polarized) and horizontally-polarized (H-polarized) radiation patterns. This disclosure is directed to a beamwidth controller 100/330 which is configured to alter permittivity and/or permeability to control a beamwidth of an antenna, and particularly dual/multi-polarization antennas and antenna arrays, although a single polarization antenna is also envisioned.

The properties of the beamwidth controller 100/330 depend on an orientation toward the propagating wave, for instance, μₓ=μ_{eff}, μ_{y}=μ_{z}=1 in the beamwidth controller 100 shown in FIG. 1. The orientation of the beamwidth controller 100/330 should be aligned with the electromagnetic wave source (e.g., the antenna) for wave incidence in order to obtain a desired outcome. This orientation dependency of the beamwidth controller 100/330 is applied to manipulate a dual/multi-polarization antenna beamwidth. By controlling the antenna polarization, for instance, if the vertical-polarization (V-pol) is aligned with the beamwidth controller 100/330 orientation, the radiation pattern of vertical polarization is more focused/defocused, without affecting the horizontal-polarization (H-pol) radiation pattern beamwidth. Note that, the focusing/defocusing of the radiation pattern will depend on the altered material properties. Thus by switching vertical polarization 312 and horizontal polarization 314 excitation in the dual-polarized antenna 310, it is possible to realize antenna beamwidth control for different polarizations. Periodic arrangement of resonator cells 110 can be applied as radome enclosures to antenna arrays for beam broadening and/or focusing in one axis without impacting the radiation pattern in other axial directions.

The beamwidth controller 100/330 may have frequency dependency and is configured to control the beamwidth of the electromagnetic wave by changing its operating frequency. The beamwidth controller 100/330 may also comprise a tunable component, and be configured to control the beamwidth of the electromagnetic wave by controlling parameters of the tunable component. Further, the beamwidth controller 100/330 may be configured to taper an amplitude of the electromagnetic wave.

FIG. 3C illustrates a comparison plot 300C of radiation patterns for vertical and horizontal polarizations with the beamwidth controller 330 arranged on top of the dual-polarized patch antenna 310. The comparison plot 300C also includes a radiation pattern of a standard patch antenna without the beamwidth controller 330.

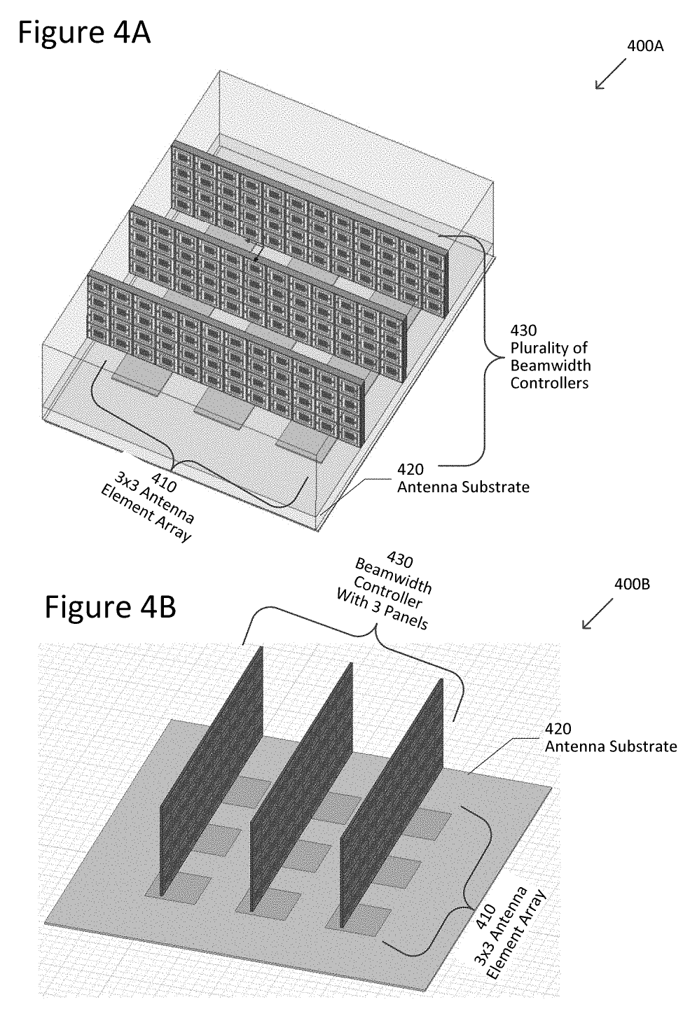

FIGS. 4A and 4B illustrate top views of an antenna system 400 in accordance with an aspect of the disclosure.

The antenna system 400 comprises a 3×3 dual-polarized patch antenna array 410 formed on an antenna substrate 420, and a plurality of beamwidth controllers 430.

The three beamwidth controllers 430 having resonator cells 110 and are placed on top of respective antenna elements of the 3×3 dual-polarized patch antenna array 410. The beamwidth controllers 430 are not limited to having the illustrated number or type of resonator cells 110, but may have any one or more of the types of resonator cells 110, such as the ones described above with respect to FIGS. 2A and 2B.

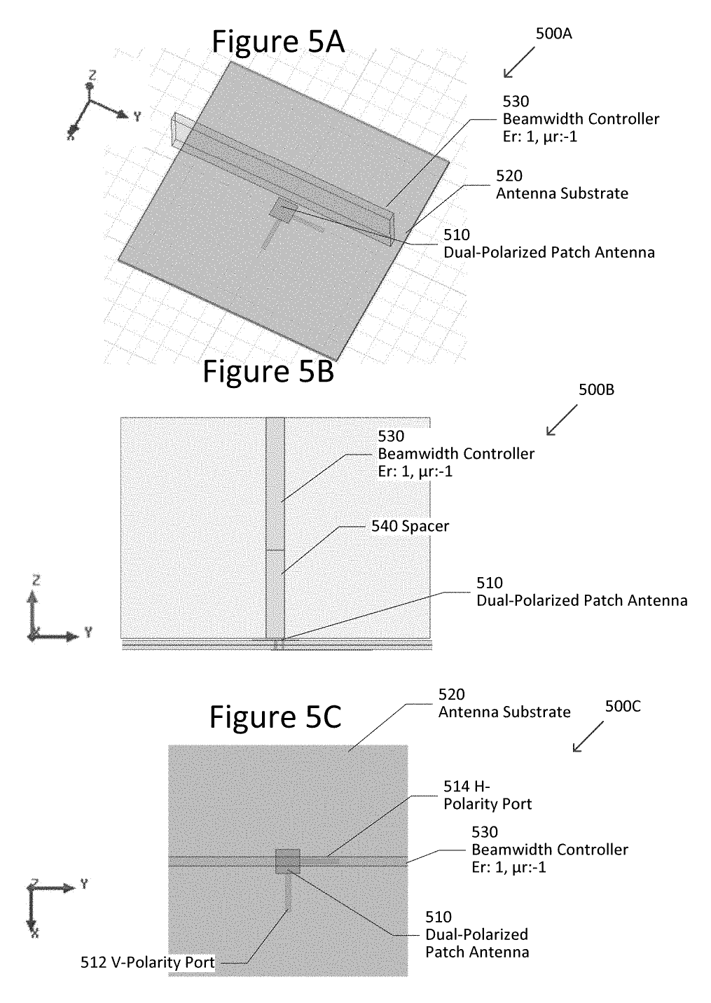

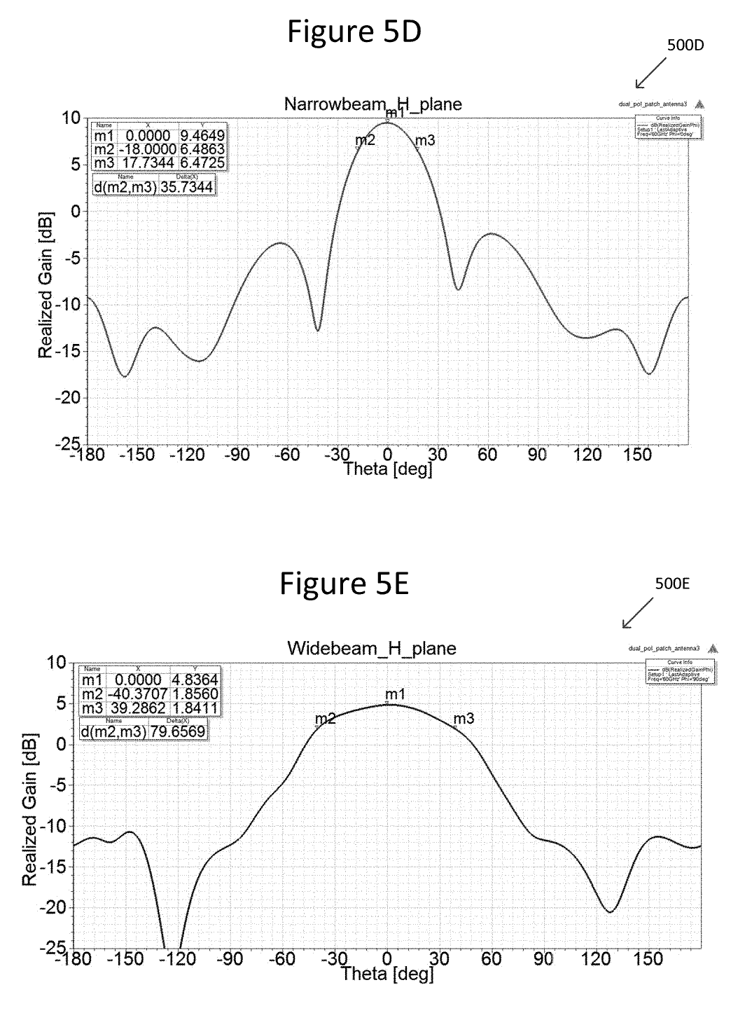

FIGS. 5A-C illustrate an antenna system 500 in accordance with an aspect of the disclosure. FIGS. 5A and 5C illustrate top views, and FIG. 5B illustrates a side view.

The antenna system 500 comprises a single dual-polarized patch antenna 510 formed on an antenna substrate 520, a beamwidth controller 530, and a spacer 540 formed between the beamwidth controller 530 and the antenna 510.

The dual-polarized patch antenna 510 comprises a vertically polarized port 512 and a horizontally polarized port 514. The spacer 540 is formed of an insulating material, and its size may be related to wavelength of the electromagnetic waves of the antenna 510.

The beamwidth controller 530 is placed on top of the antenna 510 and has assigned material properties in this example of εr=1 and μr=−1. Since the beamwidth controller 530 in this example has negative permeability, the beamwidth controller 530 is configured to have a significant impact on the vertical polarization as the magnetic field (H-field) of the vertical polarization is aligned in the Y-axis, in line with the beamwidth controller 530. The beamwidth controller 530 is configured to have a minimal effect on the horizontal polarization since the magnetic field of the horizontal polarization is perpendicular to the beamwidth controller 530, that is, the magnetic field is in the X-axis.

FIGS. 5D and 5E illustrate H-plane, in which the magnetic field is dominant, radiation patterns 500D, 500E for the antenna system 500 of FIGS. 5A-5C.

FIG. 5D illustrates the vertical-polarized H-plane radiation pattern 500D of the antenna 510 using the beamwidth controller 530. FIG. 5E illustrates the horizontal-polarized H-plane radiation pattern 500E of the antenna 510 using the beamwidth controller 530. The vertical polarization of FIG. 5D results in a narrow beamwidth, while the horizontal polarization of FIG. 5E maintains the beamwidth in an unaltered state, due to the alignment of the beamwidth controller 530 with each polarization. There is a beamwidth difference of about 44-degrees between the vertical and horizontal polarizations.

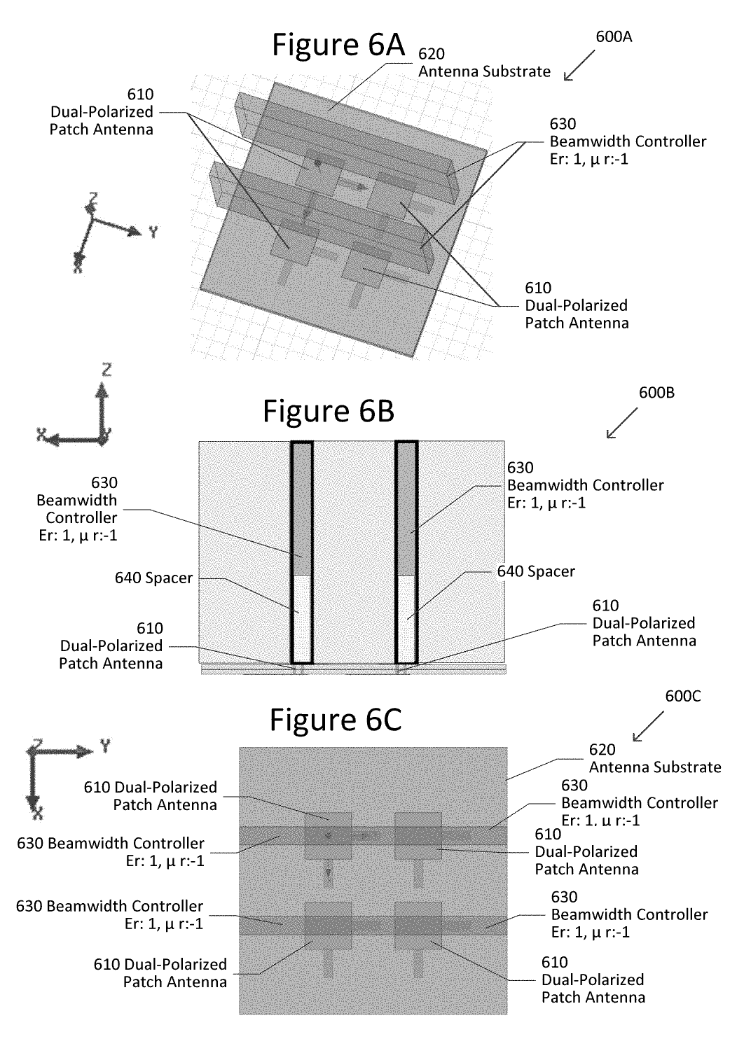

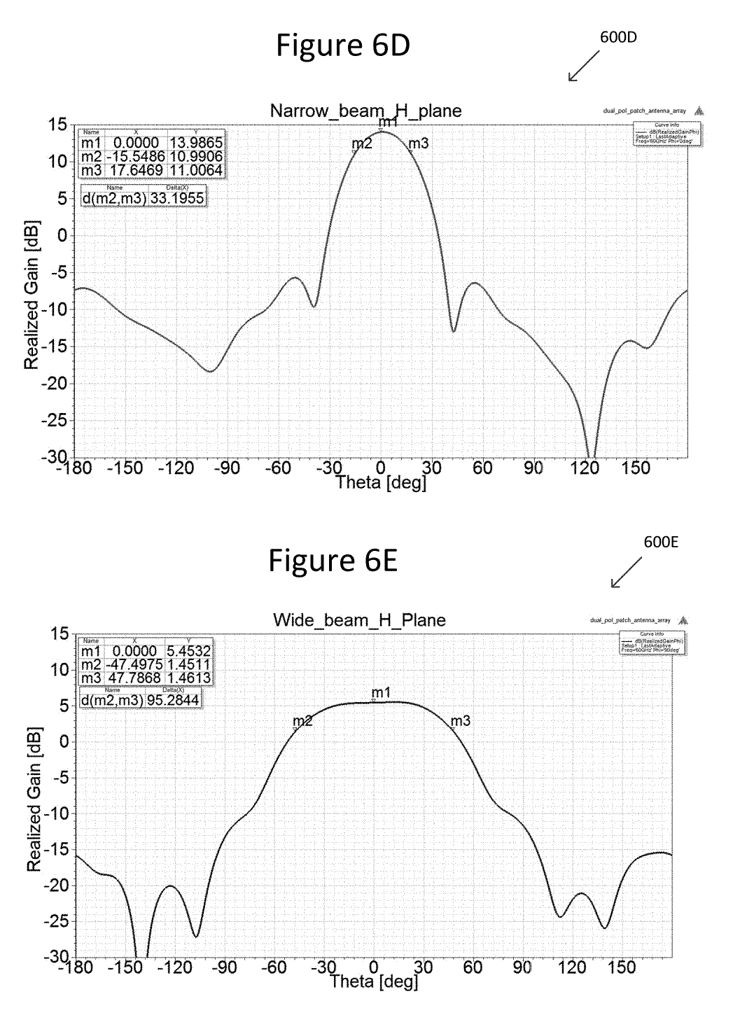

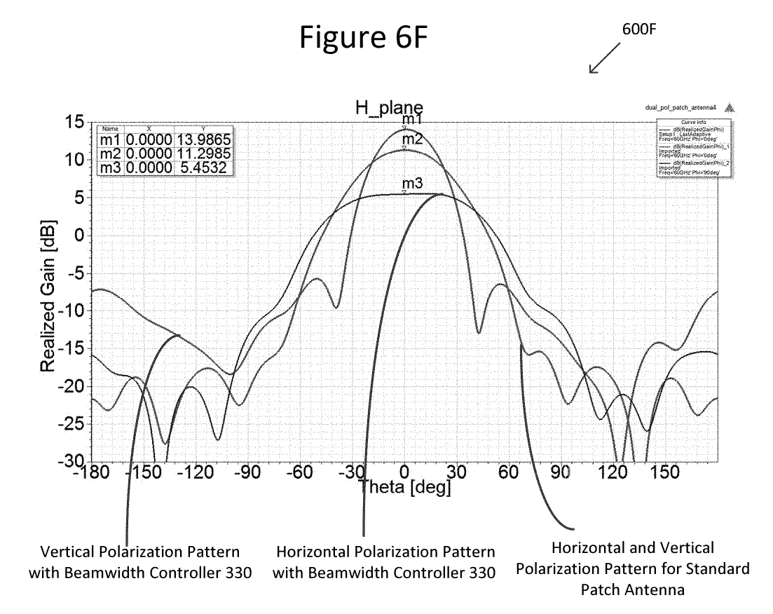

FIGS. 6A-6C illustrate an antenna system 600 in accordance with an aspect of the disclosure. FIGS. 6A and 6C illustrate top views, and FIG. 6B illustrates a side view.

The antenna system 600 comprises a 2×2 array of dual-polarized patch antennas 610 formed on an antenna substrate 620, two beamwidth controllers 630 corresponding to the two respective rows of antennas 210, and spacers 640 respectively formed between the beamwidth controllers 630 and rows of the antennas 610. The spacers 640 are formed of an insulating material, and their size may be related to wavelengths of electromagnetic waves emitted from the antennas 610.

FIGS. 6D-6F illustrate H-plane radiation patterns for the system 600 of FIGS. 6A-6C.

FIG. 6D illustrates the H-plane radiation pattern 600D for the vertically-polarized radiation pattern. FIG. 6E illustrates the H-plane radiation pattern 600E for the horizontally-polarized radiation pattern. The vertically-polarized radiation pattern 600D has a narrower beamwidth, while there is minimal impact on horizontally-polarized radiation pattern 600E. There is about 62 degrees of beamwidth difference between the vertically-polarized and the horizontally-polarizations.

FIG. 6F illustrates a comparison plot 600F of the radiation patterns for the two polarizations when the beamwidth controllers 630 are placed on top of the 2×2 array of dual-polarized patch antennas 610. The comparison plot also includes the radiation pattern of the 2×2 array of standard patch antennas without the beamwidth controller 630. The beamwidth controller 630 may be assembled to replace the radome enclosure for the antenna system.

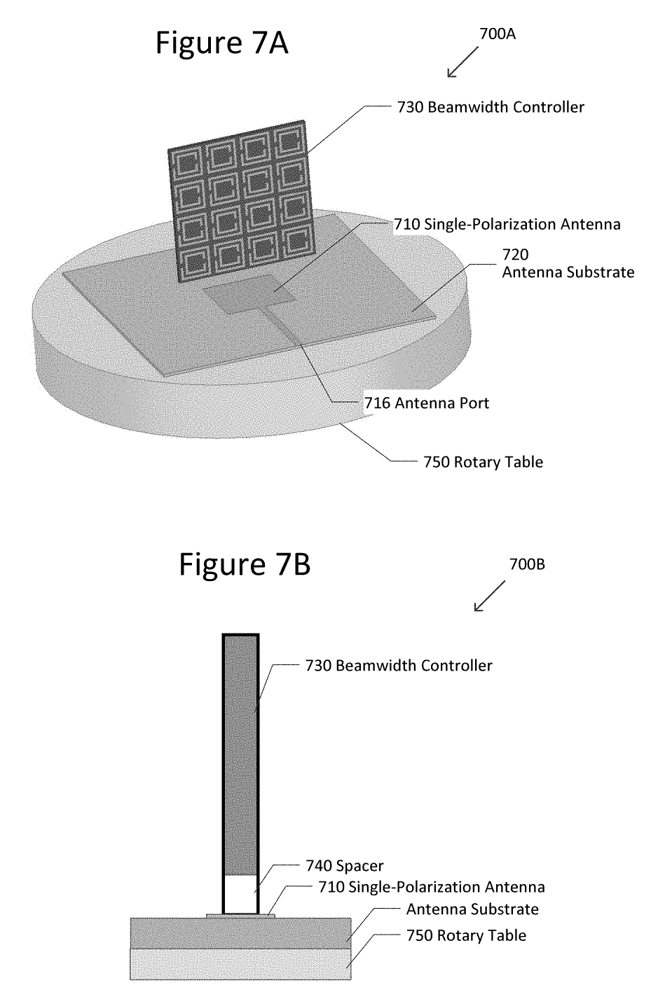

FIGS. 7A-7B illustrate an antenna system 700 in accordance with an aspect of the disclosure. FIG. 7A illustrates a top view, and FIG. 7B illustrates a side view.

The antenna system 700 comprises a single-polarity patch antenna 710 formed on an antenna substrate 720, which is in turn formed on a rotary table 750, and a beamwidth controller 730 which is physically isolated from the rotary table. The beamwidth controller 730 is aligned with a magnetic and/or electric field direction of an electromagnetic wave emitted by the antenna 710, such that when the electromagnetic wave propagates through the beamwidth controller 730, the beamwidth controller 730 is configured to resonate and induce a magnetic and/or electric field to interact with the electromagnetic wave to control a beamwidth of the electromagnetic wave based on a permittivity or permeability of the beamwidth controller 730. The rotary table 750 is turned to align the beamwidth controller 730 to have the desired impact on the electromagnetic wave emitted by the antenna 710.

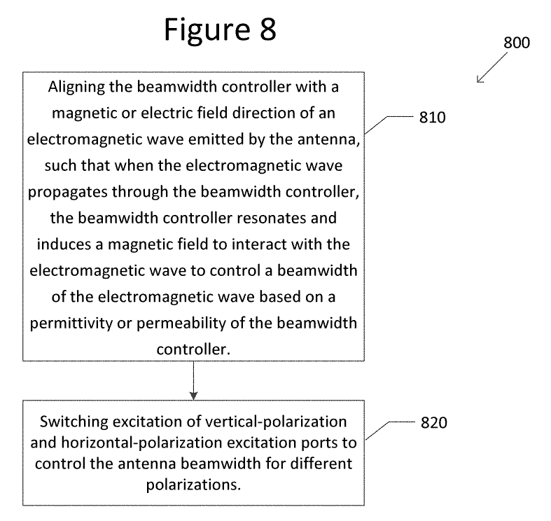

FIG. 8 illustrates a flowchart 800 of a method in accordance with an aspect of the disclosure.

At 810, the beamwidth controller 730 is aligned with a magnetic and/or electric field direction of an electromagnetic wave emitted by an antenna or array, such that when the electromagnetic wave propagates through the beamwidth controller 730, the beamwidth controller 730 resonates and induces a magnetic field to interact with the electromagnetic wave to control a beamwidth of the electromagnetic wave based on a permittivity and/or permeability of the beamwidth controller 730. In the case of a single-polarization antenna, this alignment is performed by rotating the rotary table 750. Alternatively, if the antenna is a dual-polarization antenna, excitation of vertical-polarization and horizontal-polarization excitation ports can be switched to control the antenna beamwidth for different polarizations.

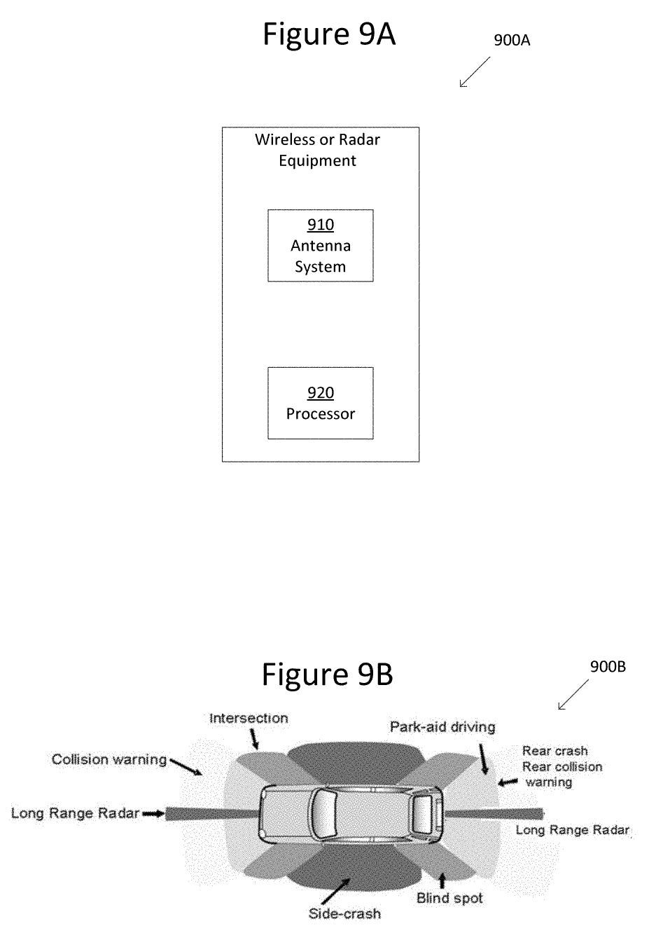

FIG. 9A illustrates wireless or radar equipment 900 in accordance with aspects of the disclosure. The wireless or radar equipment 900 comprises an antenna system 910, such as those discussed above, and a processor 920 configured to control the antenna system 910. FIG. 9B illustrates the radar or communication equipment of FIG. 9A embedded in a vehicle.

The antenna beamwidth can be designed as specified by combining the beamwidth controller having altered material properties with an antenna. For radar/sensing applications, there is a trade-off between detection Field Of View (FOV) and detection range due to a need for different requirements on antenna directivity and range. Therefore, adaptive beamwidth control improves the sensing and connectivity capabilities required for detection of target size, angle, and range. With the beamwidth controller described herein, both narrow beamwidth long-range communication/radar applications and wide beamwidth close range radar sensing for various Vehicle-To-Everything/Vehicle-To-Vehicle (V2X/V2V) application environments is possible with one antenna array architecture and assembly.

While antenna systems described above involve dual-polarization antennas, the aspects of the disclosure is also applicable to any multi-polarization antenna and antenna array. The disclosure is not limited by antenna array size and the lattice structure. Also, while the antenna systems are described with respect to broadside antennas, the aspects of the disclosure are also applicable to end-fire antennas and combination antennas demonstrating both broad side and end-fire radiation patterns.

The beamwidth controller is described as comprising an insulating material and resonator cells. It is envisioned, however, that the beamwidth controller may be comprised of any resonator cell shape, resonator alignment, and material with an altered permittivity or permeability to control a beamwidth of an electromagnetic wave.

The following examples pertain to further aspects.

Example 1 is an antenna system, comprising: an antenna configured to emit an electromagnetic wave; and a beamwidth controller disposed on the antenna and configured to: align with a magnetic or electric field direction of the electromagnetic wave; and when the electromagnetic wave at least partially or wholly propagates through the beamwidth controller, resonate and induce a magnetic or electric field with the electromagnetic wave to control a beamwidth of the electromagnetic wave based on a permittivity or permeability of the beamwidth controller.

In Example 2, the subject matter of Example 1, wherein the beamwidth controller comprises: an insulating substrate; and an array of resonator cells formed in the insulating substrate.

In Example 3, the subject matter of Example 2, wherein the resonator cells comprise Split Ring Resonators (SRRs).

In Example 4, the subject matter of Example 2, wherein the resonator cells comprise a resonator cell selected from a group of resonator cells consisting of a spherical resonator cell, a wire resonator cell, and a mushroom-shaped resonator cell.

In Example 5, the subject matter of Example 2, wherein the resonator cells comprises a plurality of types of resonator cells.

In Example 6, the subject matter of Example 1, wherein the antenna is a dual-polarization antenna, and when a horizontal polarization port of the antenna is excited, the beamwidth controller is configured to alter the beamwidth of the electromagnetic wave.

In Example 7, the subject matter of Example 6, wherein when a vertical polarization port of the antenna is excited, the beamwidth of the electromagnetic wave propagates through the beamwidth controller unaltered.

In Example 8, the subject matter of Example 1, wherein: the antenna comprises an m by n array of antenna elements, where m and n are integers greater than 1, and the beamwidth controller comprises any number of beamwidth controllers.

In Example 9, the subject matter of Example 1, wherein the antenna comprises dual-polarized patch antenna element, and the beamwidth controller is positioned perpendicular to the dual-polarized patch antenna element.

In Example 10, the subject matter of Example 1, further comprising: an antenna substrate disposed under the antenna; and a spacer formed of an insulating material and disposed between the antenna and the beamwidth controller.

In Example 11, the subject matter of Example 1, wherein the antenna system is comprised within a wireless communication system.

In Example 12, the subject matter of Example 1, wherein the antenna system is comprised within a radar system.

In Example 13, the subject matter of Example 1, wherein the antenna is a multi-polarization antenna.

In Example 14, the subject matter of Example 1, wherein the antenna is a single-polarization antenna.

In Example 15, the subject matter of Example 1, wherein the beamwidth controller has frequency dependency and is configured to control the beamwidth of the electromagnetic wave by changing its operating frequency.

In Example 16, the subject matter of Example 1, wherein the beamwidth controller comprises a tunable component, and is configured to control the beamwidth of the electromagnetic wave by controlling parameters of the tunable component.

In Example 17, the subject matter of Example 1, wherein the beamwidth controller is configured to taper an amplitude of the electromagnetic wave.

Example 18 is an antenna system, comprising: an antenna configured to emit an electromagnetic wave; and a beamwidth controlling means, disposed on the antenna, for resonating and inducing a magnetic or electric field with the electromagnetic wave to control a beamwidth of the electromagnetic wave based on a permittivity or permeability of the beamwidth controlling means when the electromagnetic wave at least partially or fully propagates through the beamwidth controlling means, wherein the beamwidth controlling means is aligned with a magnetic or electric field direction of the electromagnetic wave.

In Example 19, the subject matter of Example 18, wherein the beamwidth controlling means comprises: an insulating substrate; and an array of resonator cells arranged in the insulating substrate.

In Example 20, the subject matter of Example 19, wherein the resonator cells comprise Split Ring Resonators (SRRs).

Example 21 is a method for arranging an antenna system having a beamwidth controller and an antenna, the method comprising: aligning the beamwidth controller with a magnetic or electric field direction of an electromagnetic wave emitted by the antenna, resonating and inducing a magnetic or electric field with the electromagnetic wave to control a beamwidth of the electromagnetic wave based on a permittivity or permeability of the beamwidth controller when the electromagnetic wave at least partially or wholly propagates through the beamwidth controller.

In Example 22, the subject matter of Example 21, wherein the antenna is disposed on an antenna substrate over a rotary table, and the aligning of the beamwidth controller is performed by rotating the rotary table.

In Example 23, the subject matter of Example 22, wherein the antenna is a single-polarization antenna.

In Example 24, the subject matter of Example 21, wherein: the antenna is a dual-polarization antenna, and the method further comprises: switching excitation of vertical-polarization and horizontal-polarization excitation ports to control the antenna beamwidth for different polarizations.

While the foregoing has been described in conjunction with exemplary aspects, it is understood that the term “exemplary” is merely meant as an example, rather than the best or optimal. Accordingly, the disclosure is intended to cover alternatives, modifications and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This disclosure is intended to cover any adaptations or variations of the specific aspects discussed herein.

1. An antenna system, comprising:
an antenna configured to emit an electromagnetic wave; and
a beamwidth controller disposed on the antenna and configured to:
align with a magnetic or electric field direction of the electromagnetic wave; and
when the electromagnetic wave at least partially or wholly propagates through the beamwidth controller, resonate and induce a magnetic or electric field with the electromagnetic wave to control a beamwidth of the electromagnetic wave based on a permittivity or permeability of the beamwidth controller.

2. The antenna system of claim 1, wherein the beamwidth controller comprises:
an insulating substrate; and
an array of resonator cells formed in the insulating substrate.

3. The antenna system of claim 2, wherein the resonator cells comprise Split Ring Resonators (SRRs).

4. The antenna system of claim 2, wherein the resonator cells comprise a resonator cell selected from a group of resonator cells consisting of a spherical resonator cell, a wire resonator cell, and a mushroom-shaped resonator cell.

5. The antenna system of claim 2, wherein the resonator cells comprises a plurality of types of resonator cells.

6. The antenna system of claim 1, wherein the antenna is a dual-polarization antenna, and when a horizontal polarization port of the antenna is excited, the beamwidth controller is configured to alter the beamwidth of the electromagnetic wave.

7. The antenna system of claim 6, wherein when a vertical polarization port of the antenna is excited, the beamwidth of the electromagnetic wave propagates through the beamwidth controller unaltered.

8. The antenna system of claim 1, wherein:
the antenna comprises an m by n array of antenna elements, where m and n are integers greater than 1, and
the beamwidth controller comprises any number of beamwidth controllers.

9. The antenna system of claim 1, wherein the antenna comprises dual-polarized patch antenna element, and the beamwidth controller is positioned perpendicular to the dual-polarized patch antenna element.

10. The antenna system of claim 1, further comprising:
an antenna substrate disposed under the antenna; and
a spacer formed of an insulating material and disposed between the antenna and the beamwidth controller.

11. The antenna system of claim 1, wherein the antenna system is comprised within a wireless communication system.

12. The antenna system of claim 1, wherein the antenna system is comprised within a radar system.

13. The antenna system of claim 1, wherein the antenna is a multi-polarization antenna.

14. The antenna system of claim 1, wherein the antenna is a single-polarization antenna.

15. The antenna system of claim 1, wherein the beamwidth controller has frequency dependency and is configured to control the beamwidth of the electromagnetic wave by changing its operating frequency.

16. The antenna system of claim 1, wherein the beamwidth controller comprises a tunable component, and is configured to control the beamwidth of the electromagnetic wave by controlling parameters of the tunable component.

17. The antenna system of claim 1, wherein the beamwidth controller is configured to taper an amplitude of the electromagnetic wave.

18. An antenna system, comprising:
an antenna configured to emit an electromagnetic wave; and
a beamwidth controlling means, disposed on the antenna, for resonating and inducing a magnetic or electric field with the electromagnetic wave to control a beamwidth of the electromagnetic wave based on a permittivity or permeability of the beamwidth controlling means when the electromagnetic wave at least partially or fully propagates through the beamwidth controlling means, wherein the beamwidth controlling means is aligned with a magnetic or electric field direction of the electromagnetic wave.

19. The antenna system of claim 18, wherein the beamwidth controlling means comprises:
an insulating substrate; and
an array of resonator cells arranged in the insulating substrate.

20. The antenna system of claim 19, wherein the resonator cells comprise Split Ring Resonators (SRRs).

21. A method for arranging an antenna system having a beamwidth controller and an antenna, the method comprising:
aligning the beamwidth controller with a magnetic or electric field direction of an electromagnetic wave emitted by the antenna,
resonating and inducing a magnetic or electric field with the electromagnetic wave to control a beamwidth of the electromagnetic wave based on a permittivity or permeability of the beamwidth controller when the electromagnetic wave at least partially or wholly propagates through the beamwidth controller.

22. The method of claim 21, wherein the antenna is disposed on an antenna substrate over a rotary table, and the aligning of the beamwidth controller is performed by rotating the rotary table.

23. The method of claim 22,
wherein the antenna is a single-polarization antenna.

24. The method of claim 21, wherein:
the antenna is a dual-polarization antenna, and
the method further comprises:
switching excitation of vertical-polarization and horizontal-polarization excitation ports to control the antenna beamwidth for different polarizations.
